(19) United States
(12) Patent Application Publication
(10) Pub. No.: US 2025/0229429 A1
(43) Pub. Date: Jul. 17, 2025

(54) METHOD TO CALIBRATE A ROBOT TO A PALLET OR AN INFEED CONVEYOR

(71) Applicant: FANUC AMERICA CORPORATION, Rochester Hills, MI (US)

(72) Inventors: Ganesh Kalbavi, Rochester, MI (US); Jake Weinmann, Pontiac, MI (US)

(21) Appl. No.: 19/009,138

(22) Filed: Jan. 3, 2025

Related U.S. Application Data
(60) Provisional application No. 63/620,392, filed on Jan. 12, 2024.

(51) Int. Cl. B25J 9/16; B25J 9/00

(52) U.S. Cl. CPC B25J 9/1692; B25J 9/0093; B25J 9/1653; B25J 9/1661

(57) ABSTRACT

A system and method for calculating a robot reference frame. The method includes placing a calibration object, such as a box, at a first location, positioning the robot relative to a center of the calibration object when the calibration object is at the first location, grasping the calibration object by the robot when the calibration object is at the first location, and recording a first position value identifying the first location. The method further includes moving the calibration object from the first location to a second location using the robot, recording a second position value identifying the second location, and calculating a third position value using the first and second position values. The method also includes calculating an intermediate frame using the first, second and third position values, and calculating the reference frame using the intermediate frame and dimensions of the calibration object.

### CROSS-REFERENCE TO RELATED APPLICATIONS

This application claims the benefit of the filing date of U.S. Provisional Patent Application No. 63/620,392, titled METHOD TO CALIBRATE A ROBOT TO A PALLET OR AN INFEED CONVEYOR, filed Jan. 12, 2024.

### BACKGROUND

### Field

This disclosure relates generally to a system and method for determining a calibration reference frame for a robot and, more particularly, to a system and method for determining a calibration reference frame for a robot relative to a conveyor and a pallet, where the method employs a single calibration box and two recorded positions of the calibration box.

### Discussion of the Related Art

Robots perform a multitude of commercial tasks including pick and place operations, where the robot picks up and moves objects from one location to another location. For example, the robot may pick up boxes off of a conveyor and place the boxes on a pallet or pick up the boxes off of a pallet and place them on a conveyor. In order for the robot to effectively pick up a box, the robot typically needs to know the width, length, height and orientation of the box it is picking up so that it grasps the box at a location that is stable. Further, the robot needs to know a frame of reference or origin on the conveyor and the pallet that the box will be positioned at or be positioned relative to when being picked up. Example locations of frames of reference include the front left or right corners of the conveyor or one of the four corners of the pallet.

In order to calculate the reference frame at least three known points in space are required. Known methods for calculating the reference frame include placing three boxes at known locations on the pallet and conveyor and then moving the robot to the center of each box to record the robot position at those locations, where the reference frame is calculated from those points. However, requiring multiple boxes to perform the reference frame calculation has obvious drawbacks of complexity, time and cost.

### SUMMARY

The following discussion discloses and describes a system and method for calculating a reference frame including X, Y and Z axes that allows a robot to pick up a pick object, such as a box. The method includes placing a calibration object, such as a box, at a first location, positioning the robot relative to a center of the calibration object when the calibration object is at the first location, grasping the calibration object by the robot when the calibration object is at the first location, and recording a first position value identifying the first location. The method further includes moving the calibration object from the first location to a second location using the robot, recording a second position value identifying the second location, and calculating a third position value using the first and second position values. The method also includes calculating an intermediate frame including X, Y and Z axes using the first, second and third position values, and calculating the reference frame using the intermediate frame and dimensions of the calibration object.

Additional features of the disclosure will become apparent from the following description and appended claims, taken in conjunction with the accompanying drawings.

### BRIEF DESCRIPTION OF THE DRAWINGS

FIG. 1 is an illustration of a robot system including a robot, an infeed conveyor and a pallet;

FIGS. 2 and 3 are illustrations of the robot system depicted in FIG. 1 showing the robot positioned relative to a single calibration box at two different locations on the infeed conveyor to identify two different box positions that are used to calculate a reference frame on the conveyor;

FIG. 4 is a top view of the infeed conveyor showing the calibration box at the two different locations on the conveyor;

FIGS. 5-7 are illustrations of the robot system depicted in FIG. 1 showing the robot positioned relative to a single calibration box at three different locations on the pallet to identify three different box positions that are used to calculate a reference frame on the pallet; and

FIG. 8 is an isometric view of the pallet showing the box at the three different locations on the pallet.

### DETAILED DESCRIPTION OF THE EMBODIMENTS

The following discussion of the embodiments of the disclosure directed to a system and method for determining a calibration reference frame for a robot relative to a conveyor and a pallet is merely exemplary in nature, and is in no way intended to limit the invention or its applications or uses. For example, the described system and method have particular application for determining a calibration reference frame for a robot that picks up boxes. However, the system and method may have other applications.

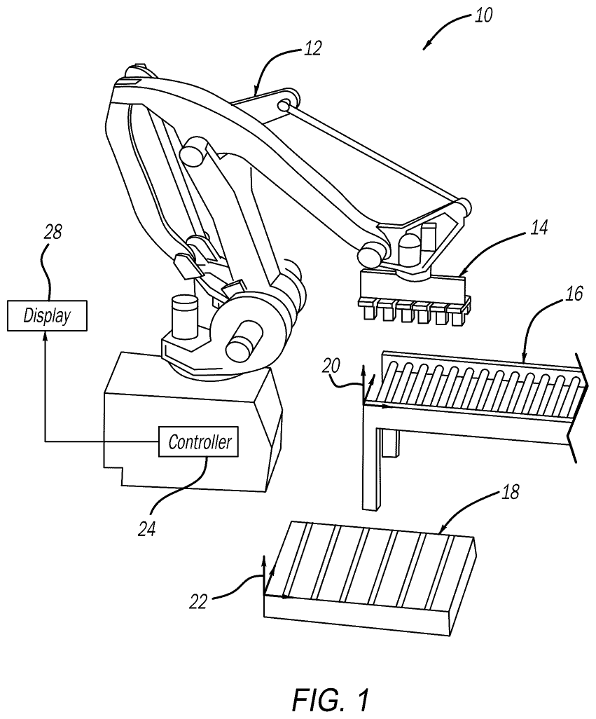

FIG. 1 is an illustration of a robot system 10 including a robot 12 having a gripper 14, such as suction cups, that is configured for picking up objects, such as boxes, from an infeed conveyor 16 and placing them on a pallet 18, or picking up objects from the pallet 18 and placing them on the conveyor 16. The system 10 is intended to represent any type of robot system that is applicable for the discussion herein, where the robot 12 can be any robot suitable for that purpose. The boxes will be rectangular, but may have various and different widths, lengths and heights. The gripper 14 needs to grasp the box at or near its center so that it is stable when being moved, and to do that the robot 12 needs to know the position and orientation of the box on the conveyor 16 and/or on the pallet 18. In order to determine the position and orientation of the box on the conveyor 16 and on the pallet 18, an X-Y-Z origin reference frame 20 relative to the conveyor 16 and an X-Y-Z reference frame 22 relative to the pallet 18 needs to be calculated to provide a reference point relative to the box when it is being picked from the conveyor 16 or the pallet 18. In this non-limiting embodiment, the reference frame 20 is calculated to be at a right front corner of the conveyor 16 and the reference frame 22 is calculated to be at a right front corner of the pallet 18. However, the reference frames 20 and 22 can be calculated to be at other locations. The length of the box is in the X direction, the width of the box is in the Y direction and the height of the box is in the Z direction.

The following is a detailed discussion of a technique for calculating the origin reference frames 20 and 22 on the conveyor 16 and the pallet 18, respectively, where only a single calibration box is employed and only two positions of the calibration box need to be recorded. A robot controller 24 controls the robot 12 and calculates the origin reference frames 20 and 22 as discussed herein. Once the calibration is complete, the location of the box and the reference frame 20 or 22 relative to the robot 12 can be viewed on a 3D display 28 to confirm accuracy.

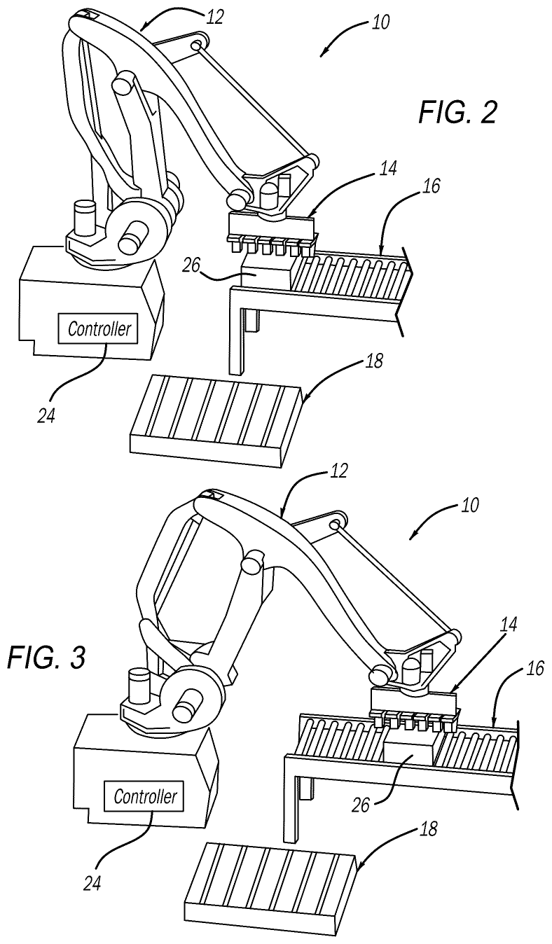

FIGS. 2 and 3 are illustrations of the robot system 10 showing the robot 12 positioning a single calibration box 26 at two different locations on the conveyor 16 to identify two different box positions that are used to calculate the reference frame 20 at the front corner of the conveyor 16. The system 10 is configured so that during operation of picking the boxes off of the conveyor the boxes are fed down the conveyor 16 so that when the box reaches the pick location, a corner of the box will be aligned with the reference frame 20. The length, width and height of the calibration box 26 is stored in the controller 24. FIG. 2 shows the box 26 at a pick location on the conveyor 16. The robot 12 is moved to a location relative to the box 26 when the box 26 is in this position so the center of the gripper 14 is positioned relative to the center of the box 26. The gripper 14 grasps the box 26 and that position of the gripper 14 is recorded in the controller 24 as point P1. The box 26 is then moved by the robot 12 to a position upstream on the conveyor 16 as shown in FIG. 3, and that position of the gripper 14 is recorded in the controller 24 as point P2. In this process, the orientation or rotation of the gripper 14 on the Z-axis relative to the box 26 does not need to be known.

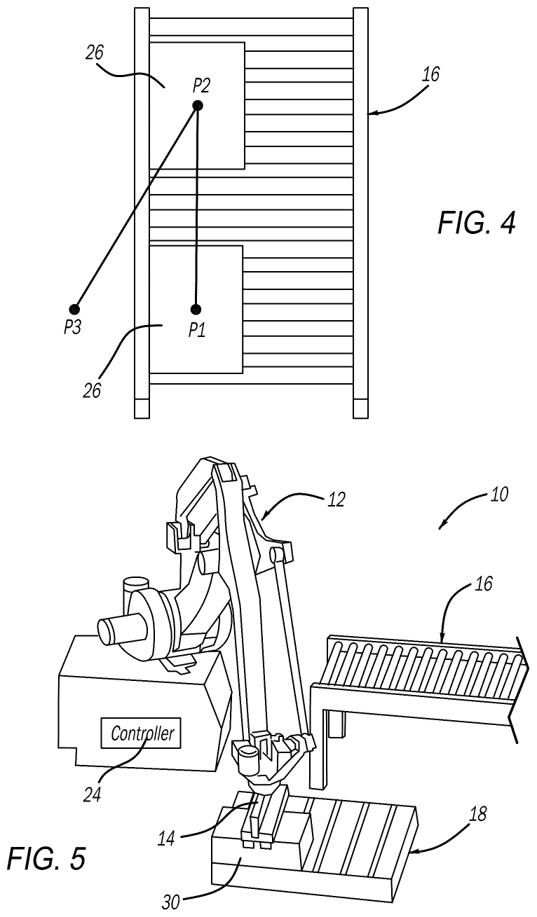

FIG. 4 is a top view of the infeed conveyor 16 showing the calibration box 26 at two different locations on the conveyor 16, where the box 26 is shown being aligned with a left side of the conveyor 16 and where the reference frame will be calculated relative to the left front corner of the conveyor 16 in this example. Recorded point P1 is shown at the center of the box 26 at the first location, recorded point P2 is shown at the center of the box 26 at the second location, and a calculated point P3 is shown in space relative thereto. The vector between the recorded points P1 and P2 can be used to calculate the point P3, discussed below, and a frame can be calculated using the points P1, P2 and P3 using, for example, the known FRAME algorithm as FRAME (P1, P2, P3). Since the calculation of the frame is relative to the center of the box 26, once the frame is calculated from the points P1, P2 and P3 using the FRAME algorithm, then one-half of the length of the box 26 is added to the X-axis of the frame and one-half of the width of the box 26 is added to the Y-axis of the frame to obtain the reference frame 20.

The point P3 can be calculated from the recorded points P1 and P2 as follows. A temporary point P4 is calculated by adding 300 mm to point P1, and an intermediate frame, i.e., FRAME (P1, P2, P4), is calculated. The negative Z-axis of the intermediate frame coincides with the positive Y-axis of the reference frame 20. Using the intermediate frame, the point P3 can be calculated using the following code: tmp_frm=FRAME (P1, P2, P4). P5=(0, 0, 300, 0, 0, 0). P3=tmp_frm: INV (P5). Then, set point P3 W P R values to be the same as the point P1. If the robot 12 is calibrated using the box 26 positioned on the left side of the conveyor 16 as shown in FIG. 4, the origin used by the algorithm is rotated about the Z-axis by −90°. Particularly, instead of subtracting boxlen/2, boxlen/2 is added and tmp_frm=FRAME (P1, P2, P3); P4=(0, 0, 0, 0, 0, −90), and tmp_frm=tmp_frm:INV(P4).

If the orientation of the box 26 is as shown in FIG. 4, then the orientation of the box 26 is determined by the origin on the conveyor 16 or the pallet 18 as O=OB:INV(−BoxLen/2, −BoxWid/2, −BoxHgt, 0, 0, 0), and if the orientation of the box 26 is as shown in FIGS. 2 and 3, then the orientation of the box 26 is determined by the origin on the conveyor 16 or pallet 18 as O=OB:INV(−BoxWid/2, −BoxLen/2, −BoxHgt, 0, 0, 0). For the pallet 18, in addition to these calculations the orientation of the pallet 18 (width on length or length on length) is also calculated based on the lengths of the vectors formed by points P1P2 and points P1P3, and adding in the box length and box width accordingly.

If the conveyor 16 is tilted by an angle theta along the upstream/downstream direction (about p), then the frame as calculated by the algorithm above will not have the correct value. In order to compensate for the tilt, the point P3 is calculated by the algorithm as follows. X=P1.x−P2.x; Y=P1.Y−P2.Y; Z=P1.Z−P2.Z; C=\sqrt{X²+Y²+Z²}; A=\sqrt{X²+Y²}; and theta=acos(C/A).

In an alternate embodiment, it may not be necessary to use a calibration box, where the points P1 and P2 can be recorded only by the position of the gripper 14 without gripping a box. In this embodiment, the dimensions of the gripper 14 will need to be known. The intermediate frame is calculated relative to the gripper 14 and the reference frame 20 is calculated based on the dimensions of the gripper 14.

In yet another alternate embodiment, if the orientation of the gripper 14 relative to the calibration box 26 is known, then the reference frame 20 can be calculated by only recording the point P1 in the manner discussed above, and calculating the reference frame 20 from that data.

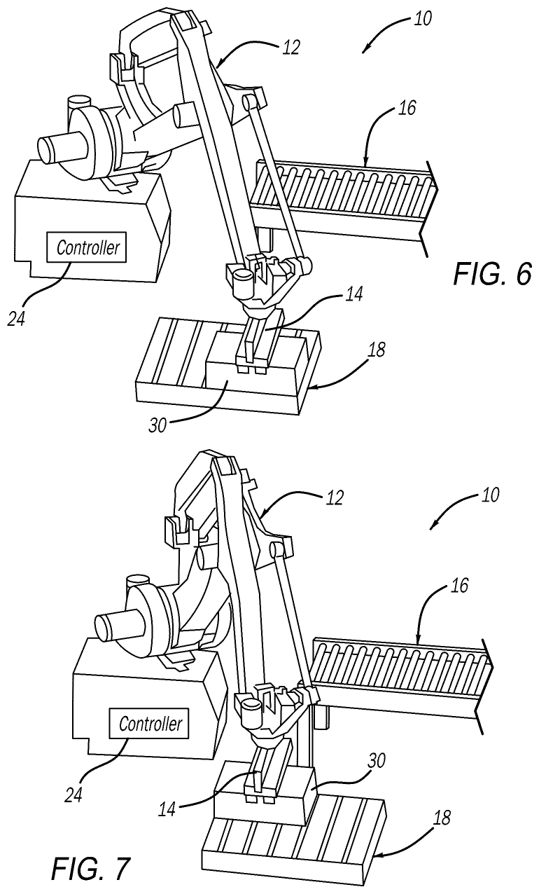

FIGS. 5-7 are illustrations of the robot system 10 showing the robot 12 positioning a single calibration box 30 at three different locations on the pallet 18 to identify and record three different box points P1, P2 and P3 that are used to calculate the reference frame 22 in the same manner as discussed above. The length, width and height of the calibration box 30 is stored in the controller 24. FIG. 5 shows the box 30 positioned at a front right corner of the pallet 18, which is the location of the origin or reference frame 22. The robot 12 is moved to a location relative to the box 30 when the box 30 is in this position so the center of the gripper 14 is positioned relative to the center of the box 30. The gripper 14 grasps the box 30 and that position of the gripper 14 is recorded in the controller 24 as point P1. The box 30 is then moved by the robot 12 to a right back corner of the pallet 18 as shown in FIG. 6, and that position of the gripper 14 is recorded in the controller 24 as point P2. The box 30 is then moved by the robot 12 to a left front corner of the pallet 18 as shown in FIG. 7, and that position of the gripper 14 is recorded in the controller 24 as point P3.

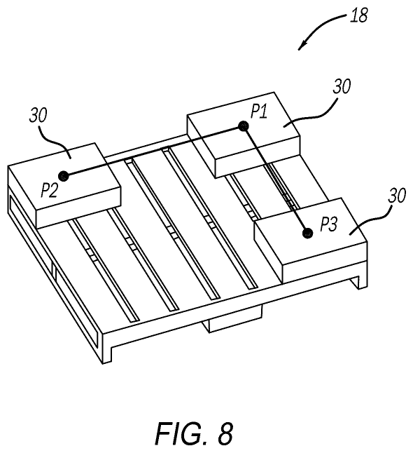

FIG. 8 is an isometric view of the pallet 18 showing the box 30 at the three different locations on the pallet 18. It is noted that the reference frame 22 can be determined by only knowing the recorded position of the points P1 and P2 or the points P1 and P3 or the points P2 and P3, where the unknown point is calculated in the manner discussed above. It is further noted that the tilt of the pallet 18 can also be calculated in the manner discussed above to correct the reference frame 22, if necessary.

The algorithm wants to process the recorded locations of the points P1, P2 and P3 for the locations of the box 30 as shown in FIG. 8. However, if the user changes the order of how the box 30 is placed during the calibration process, for example, placing the box 30 at the front left corner of the pallet 18 second and the rear right corner of the pallet 18 third, the process will still be able to accurately calculate the reference frame 22. Specifically, since the reference frame 22 has a Z-axis that is “pointing up” relative to the surface of the conveyor 16 or the pallet 18, taking the cross product of the two vectors P1P2 and P1P3 can determine if the points P2 and P3 are in the correct order for the FRAME calculation. If the cross-product Z value is positive, the frame should be FRAME (P1, P2, P3), and if the cross-product Z value is negative, the frame should be FRAME (P1, P3, P2).

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for calculating a reference frame including X, Y and Z axes that allows a robot to pick up a pick object, said method comprising:
placing a calibration object at a first location;
positioning the robot relative to a center of the calibration object when the calibration object is at the first location;
grasping the calibration object by the robot when the calibration object is at the first location;
recording a first position value identifying the first location;
moving the calibration object from the first location to a second location using the robot;
recording a second position value identifying the second location;
calculating a third position value using the first and second position values;
calculating an intermediate frame including X, Y and Z axes using the first, second and third position values; and
calculating the reference frame using the intermediate frame and dimensions of the calibration object.

2. The method according to claim 1 wherein calculating an intermediate frame includes using a FRAME algorithm.

3. The method according to claim 1 wherein calculating an intermediate frame includes using a fourth position value.

4. The method according to claim 1 wherein the first location is a pick location on a conveyor where the robot picks up the pick object, the second location is a location upstream of the pick location on the conveyor and the third position value is in space relative to the conveyor.

5. The method according to claim 4 wherein the calibration object is a calibration box and the dimensions are a width, length and height of the calibration box.

6. The method according to claim 4 wherein the reference frame is at a front right corner or a front left corner of the conveyor.

7. The method according to claim 4 wherein calculating an intermediate frame includes compensating for a tilt of the conveyor.

8. The method according to claim 1 wherein the first location is a corner of a pallet, the second location is another corner of the pallet and the third position value is at yet another corner of the pallet.

9. The method according to claim 8 wherein the calibration object is a calibration box and the dimensions are a width, length and height of the calibration box.

10. The method according to claim 8 wherein calculating an intermediate frame includes compensating for a tilt of the pallet.

11. The method according to claim 1 further comprising displaying the reference frame and the calibration object relative to the robot on a 3D display.

12. A method for calculating a reference frame including X, Y and Z axes that allows a robot to pick up a pick box off of a conveyor, said method comprising:
placing a calibration box at a pick location on the conveyor where the robot picks up the pick object;
positioning the robot relative to a center of the calibration box when the calibration box is at the pick location;
grasping the calibration box by the robot when the calibration box is at the pick location;
recording a first position value identifying the pick location;
moving the calibration box from the pick location to a location upstream of the pick location on the conveyor;
recording a second position value identifying the location upstream of the pick location on the conveyor;
recording a third position value that is in space relative to the conveyor;
calculating an intermediate frame including X, Y and Z axes using the first, second and third position values; and
calculating the reference frame using the intermediate frame and a width, length and height of the calibration box.

13. The method according to claim 12 wherein calculating an intermediate frame includes using a FRAME algorithm.

14. The method according to claim 12 wherein calculating an intermediate frame includes compensating for a tilt of the conveyor.

15. The method according to claim 12 wherein the reference frame is at a front right corner or a front left corner of the conveyor.

16. A method for calculating a reference frame including X, Y and Z axes that allows a robot to pick up a pick box off of a pallet, said pallet having four corners where the reference frame is at one of the corners, said method comprising:
placing a calibration box at a first corner of the pallet;
positioning the robot relative to a center of the calibration box when the calibration box is at the first corner;
grasping the calibration box by the robot when the calibration box is at the first corner;
recording a first position value identifying a location of the first corner;
moving the calibration box from the first corner to a second corner of the pallet using the robot;
recording a second position value identifying a location of the second corner;
moving the calibration box from the second corner to a third corner of the pallet using the robot;
recording a third position value identifying a location of the third corner;
calculating an intermediate frame including X, Y and Z axes using the first, second and third position values; and
calculating the reference frame using the intermediate frame and a width, length and height of the calibration box.

17. The method according to claim 16 wherein calculating an intermediate frame includes using a FRAME algorithm.

18. The method according to claim 16 wherein calculating an intermediate frame includes compensating for a tilt of the pallet.

19. A method for calculating a reference frame including X, Y and Z axes that allows a robot to pick up an object, said robot including a gripper having known dimensions, said method comprising:
positioning the gripper at a first location;
recording a first position value identifying the first location;
moving the gripper from the first location to a second location;
recording a second position value identifying the second location;
calculating a third position value using the first and second position values;
calculating an intermediate frame including X, Y and Z axes using the first, second and third position values; and
calculating the reference frame using the intermediate frame and the dimensions of the gripper.

20. A method for calculating a reference frame including X, Y and Z axes that allows a robot to pick up a pick object using a gripper, said gripper having a known orientation, said method comprising:
placing a calibration object at a first location;
positioning the robot relative to a center of the calibration object when the calibration object is at the first location;
grasping the calibration object by the robot when the calibration object is at the first location;
recording a position value identifying the first location;
calculating an intermediate frame including X, Y and Z axes using the first position value and the orientation of the gripper; and
calculating the reference frame using the intermediate frame.
